(19) United States
(12) Patent Application Publication
(10) Pub. No.: US 2024/0097474 A1
(43) Pub. Date: Mar. 21, 2024

(54) CHARGING STATION FOR CHARGING PLURALITY OF BATTERIES

(71) Applicant: Honda Motor Co., Ltd., Tokyo (JP)

(72) Inventor: Kyusang Ro, Chapel Hill, NC (US)

(21) Appl. No.: 17/945,938

(22) Filed: Sep. 15, 2022

(51) Int. Cl. H02J 7/00

(52) U.S. Cl. CPC H02J 7/00714; H02J 7/0013; H02J 7/0049

(57) ABSTRACT

A charging station includes a plurality of charging terminals to facilitate a charging of a plurality of batteries. A controller charges one of the plurality of batteries at a first charging current and in the first charging mode, and controls the charging of one or more remaining batteries of the plurality of batteries to limit a total charging current of the charging station below a threshold value. The one or more remaining batteries are charged at a second charging current and in the first charging mode. Further, the controller shifts the charging of the one of the remaining batteries being charged at the second charging current from the second charging current to the first charging current in response to a completion of the charging of the one of the plurality of batteries being charged at the first charging current to a predetermined value.

### BACKGROUND

The disclosed subject matter relates, generally, to a charging station for charging a plurality of batteries. More particularly, the disclosed subject matter relates to a charging station that facilitates quick charging of the plurality of the batteries simultaneously without blowing a fuse associated with external power supply unit.

Now a days, the garden equipment are generally electrically powered tools, and include similar type of batteries. For example, an electrical lawn mower and an electrical trimmer have same type of batteries. Users, generally, wish to quickly charge each of the multiple batteries. However, for so doing, a user either needs to have multiple charges for quick charging of the multiple batteries simultaneously, or charge one battery at a time. Charging batteries sequentially with one battery being charged at a time increases overall charging time, and is undesirable to the users. Also, using multiple chargers for simultaneously charging the multiple batteries is expensive. Moreover, a quick charger supplies a relatively higher current to a battery for quick charging. Accordingly, multiple quick chargers, during simultaneously charging of the multiple batteries, draw a large amount of current from an electrical power supply, causing a blowing of a fuse of the electrical power supply, which is undesirable.

### SUMMARY

In accordance with one embodiment of the present disclosure, a charging station for charging a plurality of batteries is provided. The charging station includes a plurality of charging terminals to facilitate the charging of the plurality of batteries, and a controller arranged in communication with the plurality of charging terminals and configured to control the charging of the plurality of batteries in a first charging mode and a second charging mode. The controller is configured to charge one of the plurality of batteries at a first charging current and in the first charging mode, and control the charging of one or more remaining batteries of the plurality of batteries to limit a total charging current of the charging station below a threshold value. The one or more remaining batteries are charged at a second charging current and in the first charging mode. The controller is configured to shift the charging of the one of the remaining batteries being charged at the second charging current from the second charging current to the first charging current in response to a completion of the charging of the one of the plurality of batteries being charged at the first charging current to a predetermined value. The first charging current is smaller of a first current value and a maximum permissible current of a battery determined to be charged at the first charging current.

In accordance with another embodiment of the present disclosure, a charging station for charging a plurality of batteries is provided. The charging station includes a plurality of charging terminals to facilitate the charging of the plurality of batteries, and a controller arranged in communication with the plurality of charging terminals. The controller is configured to control the charging of the plurality of batteries in a first charging mode and a second charging mode. Also, the controller is configured to determine a priority order of the charging of the plurality of batteries, and control the charging of the plurality of batteries according to the priority order. The controller is configured to charge one of the plurality of batteries having a highest priority at a first charging current and in the first charging mode. Moreover, the controller is configured to control the charging of one or more remaining batteries of the plurality of batteries to limit a total charging current of the charging station below a threshold value. The one or more remaining batteries are charged at a second charging current and in the first charging mode. The controller is further configured to shift the charging of the one of the remaining batteries being charged at the second charging current from the second charging current to the first charging current in response to a completion of the charging of the one of plurality of batteries being charged at the first charging current to the predetermined value. The first charging current is smaller of a first current value and a maximum permissible current of a battery determined to be charged at the first charging current.

In accordance with yet a further embodiment of the present disclosure, a method for charging a plurality of batteries is provided. The method includes determining, by a controller, a priority order of the charging of the plurality of batteries connected to a plurality of charging terminals of a charging station, and controlling, by the controller, the charging of the plurality of the batteries according to the priority order. The method further includes charging, by the controller, a battery having a highest priority among the plurality of batteries at a first charging current and in a first charging mode, and controlling, by the controller, the charging of one or more remaining batteries of the plurality of batteries to limit a total charging current of the charging station below a threshold value. The one or more remaining batteries are charged at a second charging current and in the first charging mode. The method also includes shifting the charging of one of the one or more remaining batteries being charged at the second charging current from the second charging current to the first charging current in response to a completion of the charging of the battery being charged at the first charging current to the predetermined value. The first charging current is smaller of a first current value and a maximum permissible current of a battery determined to be charged at the first charging current.

### BRIEF DESCRIPTION OF THE DRAWINGS

Certain embodiments of the present disclosure will be better understood from the following description taken in conjunction with the accompanying drawings in which:

FIG. 1 is a block diagram a charging station depicting a quick charger and a connector suitable to be removably coupled to the quick charger, according to an embodiment of the disclosure.

FIG. 2 is a block diagram of the charging station depicting various internal components of the quick charger, according to an embodiment of the disclosure.

### DETAILED DESCRIPTION OF EXEMPLARY EMBODIMENTS

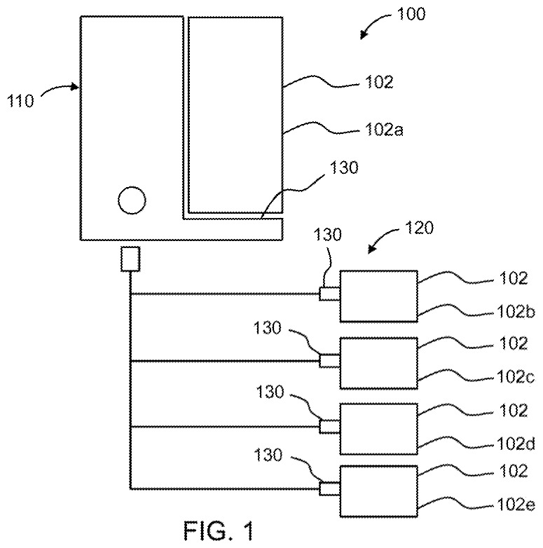

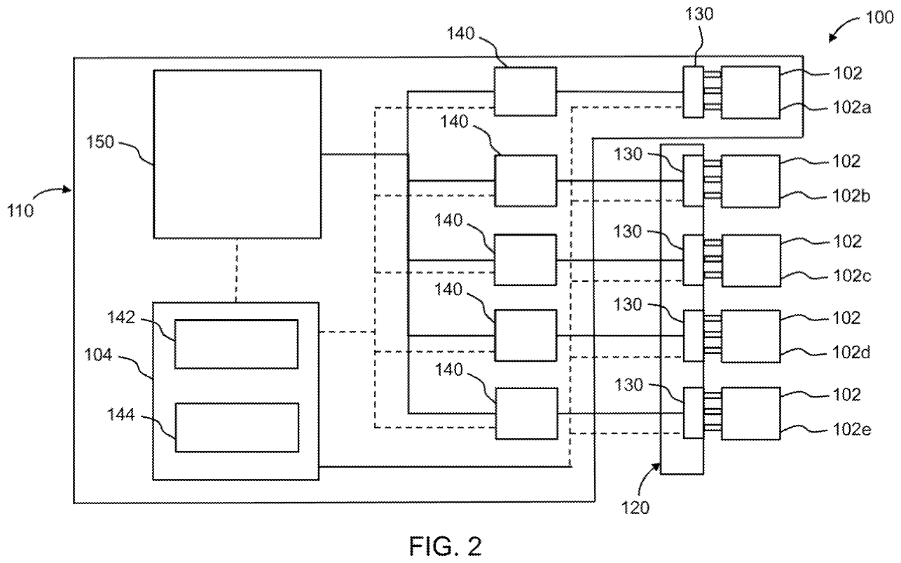

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-2, wherein like numbers indicate the same or corresponding elements throughout the views.

Referring to FIGS. 1 and 2, a charging station 100 adapted to charge a plurality of batteries 102 simultaneously while keeping a total charging current below a threshold value. In an embodiment, the threshold value corresponds to a current limit of a fuse of an electric power supply to which the charging station 100 is connected, and is predefined and prestored inside a controller 104 of the charging station 100. As shown, the charging station 100 includes a quick charger 110 adapted to connect to the electrical power source, and a connector 120 adapted to be removably connected to the quick charger 110 and enables the charging of the plurality of batteries 102. The quick charger 110 and the connector 112 together include a plurality of the charging terminals 130 to which the plurality of batteries 102 may be connected for charging. Although, the connector 120 is shown to be removably connected to the quick charger 110, it may be appreciated that the connector 120 is integrally formed with the quick charger 110, and accordingly, the quick charger 110 defines the plurality of charging terminals 130 to enable charging of the plurality of batteries 102. In the embodiment shown in FIGS. 1 and 2, the quick charger 110 defines one charging terminal 130 and the connector 120 defines four charging terminals 130. Accordingly, the five batteries 102a, 102b, 102c, 102d, 102e can be connected to the charging station simultaneously. However, it may be appreciated that the charging station 100 having two charging terminals 130 or more than two charging terminals 130 is contemplated according to the embodiments of the present disclosure.

The charging station 100 further includes a plurality of FETs 140 (field effect transistors) arranged in electrical communication with the plurality of charging terminals 130 to control the charging currents supplied to the plurality of batteries 102. It may be appreciated that one FET 140 is associated with one charging terminal 130 and controls the flow of current and amount of the current provided to the associated charging terminal 130. Further, the charging station 100 includes the controller 104 to control the charging of the plurality of batteries 102 connected to the plurality of charging terminals 130. Moreover, each FET 140 is configured to facilitate a determination of a state of charge of the associated battery 102 connected with the associated charging terminal 130, and a determination of a voltage of the associated battery 102. Moreover, the FET 140 is configured to determine a capacity of the associated battery 102, and is communication with the controller 104 to share the data of the associated battery with the controller 104. In an embodiment, the controller 104 may control the FETs 140 to enable or disable the supply of the charging currents to the associated batteries 102.

In an embodiment, the controller 104 may include a processor 142 for executing specified instructions, which controls and monitors various functions associated with charging station 100, and its components, for example, the FETs 140, the charging terminals 130, etc. The processor 142 may be operatively connected to a memory 144 for storing instructions related to the control of the charging station 100.

The memory 144 may be integrated into the controller 104, but those skilled in the art will understand that the memory 144 may be separate from the controller 104 but onboard the charging station 100, and/or remote from the controller 104 and the charging station 100, while still being associated with and accessible by the controller 104 to store information in and retrieve information from the memory 144 as necessary during the operation of the charging station 100. Although the processor 142 is contemplated, it is also possible and contemplated to use other electronic components such as a microcontroller, an application specific integrated circuit (ASIC) chip, or any other integrated circuit device.

The processor 142 is configured to control a total charging current provided to the plurality of batteries 102 to a level below the threshold value. In an embodiment, the charging station 100 may include a current limiter 150 arranged between the external power supply unit and the charging terminals 130 (i.e., FETs 140), and control the current drawn or provided to the FETs 140 to a value below or equal to the threshold value. The current limiter 150 is in communication with the controller 104 and controls the total charging current based on the inputs from the controller 104. Also, as the current limiter 150 may be in electrical communication with the FETs 140, and the current limiter 150 may limit the charging current provided to each of the FETs 140 based on the inputs from the controller 104.

Moreover, the processor 142 is configured to charge each of the batteries 102 in a first charging mode and a second charging mode. The first charging mode also refers to a quick charging mode in which a battery is charged in a constant current mode, while the second charging mode refers to a slow charging mode in which a battery 102 is charged in a constant voltage mode. In an embodiment, the processor 142 is configured to charge the one or more batteries 102 at a current less than or equal to a first current value in the first charging mode. In an embodiment, the first current value is 10 amperes. In the first charging mode, the current at which each of the one or more batteries 102 being charged simultaneously depends upon one or more of the maximum permissible current of each of the one or more batteries 102, the first current value, and the threshold value. The number of batteries 102 being charged by the charging station 100 at any instant depends upon the total charging current which is kept below the threshold value.

In an embodiment, the controller 104 (i.e., the processor 142) is configured to prioritize the charging of the plurality of batteries 102 if more than one battery 102 is connected to the charging station 100. Accordingly, the controller 104 determines a priority order of charging of the plurality of batteries 102 connected to the charging station 100. For example, when five batteries 102a, 102b, 102c, 102d, 102e are connected to the charging station 100, the controller 104 determines the priority order for charging the batteries 102 to keep the total charging current below the threshold value. The processor 142 is configured to charge a battery having a first priority (i.e., highest priority), for example, the first battery 102a, at a first charging current and in the first charging mode, and one or more remaining batteries, for example, one or more of the batteries 102b, 102c, 120d, 102e, at a second charging current. In an embodiment, the first charging current is smaller of a first current value and a maximum permissible current the battery determined to be charged at the first charging current, for example, the first battery 102a. In an embodiment, the processor 142 may charge the first battery 102a at the first current value if the maximum permissible current of the first battery 102a is greater than the first current value. It may be appreciated that the maximum permissible current of a battery is determined based on the C (charge) rate of the battery. Alternatively, the processor 142 may control the associated FET 140 to charge the first battery 102a at the maximum permissible current of the first battery 102a if the maximum permissible current of the first battery 102a is less than the first current value.

Further, a battery having a second priority, for example, the second battery 102b, is charged at the second charging current. The controller 104 determines the second charging current such that the total charging current of the batteries being charged at any instant remains below the threshold value. Accordingly, for determining the second charging current for the second battery 102b, the controller 104 may determine a remaining current value by subtracting the charging current (i.e., the first charging current) of the first battery 102a from the threshold value. In an embodiment, the controller 104 may select the second charging current 102b for the second battery 102b from one of the remaining current value, the maximum permissible current of the second battery 102b, or a second current value. In some embodiments, the second battery 102b is charged at the maximum permissible current for the second battery 102b when the remaining current value obtained by subtracting the charging current of the first battery 102a from the threshold value is greater than the maximum permissible current of the second battery 102b. Alternatively, the second battery 102b may be charged at the remaining current value obtained by subtracting the charging current of the first battery 102a from the threshold value. In an embodiment, the processor 142 may control the charging of the second battery 102b at the second current value if the remaining current value obtained by subtracting the charging current of the first battery 102a from the threshold value is less than the maximum permissible current of the second battery 102b and greater than the second current value. In some embodiments, the second current value is 3 A. The controller 104 may determine the charging current for the batteries having third priority, fourth priority, and the fourth priority in a similar to keep the total charging current of all the batteries being charged at any instant below the total charging current.

In some embodiments, the controller 104 may disable the charging of the batteries having third, fourth, and fifth priorities, for example, third battery 102c, the fourth battery 102d, and the fifth battery, if the remaining current value obtained by subtracting the summation of the charging currents of the first battery 102a and the second battery 102b is less than the second current value or is below or equal to a predetermined limit. In an embodiment, the predetermined limit is zero ampere, however, any other predetermined limit is also possible. In some embodiments, the controller 104 may initiate the charging of the third battery 102c along with the first battery 102a and the second battery 102b if a remaining current value obtained by subtracting the first charging current of the first battery 102a and the second current charging current 102b is above the second current value. The controller 104 charge the third battery 102c at a second charging current associated with the third battery 102c. The controller 104 may determine a value of the second charging current based on the remaining current value, the second current value, and the maximum permissible current of the third battery. Similarly, the controller 104 may enable or disable the charging of the fourth battery 102d and the fifth battery 102e.

The controller 104 may initiate the charging of one or remaining batteries, for example, one or more of the third battery 102c, the fourth battery 102d, and the fifth battery 102e having lower priorities when the charging of the first battery 102a is completed or switching of the charging mode from the first charging mode to the second charging mode. In an embodiment, the controller 104 is configured to switch/change the charging of a battery, for example, the first battery 102a, from the first charging mode to the second charging mode when a charge value of the battery, for example, the first battery 102a, reaches a predetermined value. In an embodiment, the predetermined value may be eighty percent of a charge value associated with a full charge level o of the battery. After completion of the charging of the first battery 102a or switching of the charging mode of the first battery 102a to the second charging mode, the controller 104 shifts the charging of the second battery 102b at the first current value or maximum permissible current of the second battery 102b from the second charging current, and determines and controls the charging current of the third battery 102c in a similar manner as that of the second battery 102b during the charging of the first battery 102a as discussed above. In this manner, the controller 104 may keep shifting the charging current of the batteries from a second charging current to a first charging current as per the priority order and starts/initiate/enable charging of the one or more of the batteries 102 for which charging is previously disable upon charging of the battery being charged with the first charging current to the predetermined value, while keeping the total charging current below the threshold value. In this manner, the controller 104 prevents a blowing of the fuse of the external power supply.

In some embodiments, the controller 104 is configured to the charge the first battery 102a at the first current value and the second battery 102b at the second current value, and the summation of the first current value and the second current value is equal to or below the threshold value. Accordingly, the controller 104 charges only two batteries simultaneously. The controller 104 starts the charging of the battery having the third priority, i.e., the third battery 102c, only after completion of the charging of the first battery 102a or when charging mode of the first battery 102a is switched to the second charge mode. In such a scenario, the controller 104 may start the charging of the second battery 102b at the first current value, and charges the third battery 102c at the second current value. Similarly, the processor 142 may control the charging of the third battery 102c at the first current value and the charging of the fourth battery 102d at the second current value upon completion of the charging of the second battery 102b or switching of the charging mode of the second battery 102b to the second charging mode. In this manner, the processor 142 charges the batteries 102 connected to the charging station 100, while keeping the total current drawn from the external power supply unit less than the threshold value-thereby prevents a blowing of the fuse. The controller 104 switches the charging mode to the second charging mode when a charge level of the battery 102 is above of a predetermined value, and fully charge the battery 102 from the predetermined value in the second charging mode.

In an embodiment, the controller 104 (i.e., the processor 142) determines the priority order of charging of the plurality of batteries 102 based on the voltages of the batteries 102. The controller 104 may determine the priority order of the charging of the batteries 102 based on the voltages when the batteries 102 that are connected to the charging station 100 are of same size. In an embodiment, the sizes of the batteries 102 are considered equal if the capacities of the batteries 102 in the ampere-hours are equal. Upon determination of the batteries 102 being of equal sizes, the controller 104 may determine/detect a voltage of the each of the batteries 102 and assigns the priorities of the charging of the batteries 102 in descending order of their voltages. For example, a battery of the plurality of batteries 102 having the highest voltage is assigned the first priority (i.e., highest priority), while a battery of the plurality of batteries 102 having lowest voltage is assigned the lowest priority. For example, five batteries of equal sizes are connected to the charging station for charging. The five batteries include the first battery 102a having a voltage of 24V, the second battery 102b having a voltage of 20V, the third battery 102c having a voltage of 18V, and the fourth battery 102d has a voltage of 16V, and the fifth battery 102e has a voltage of 12V. Accordingly, the controller 104 assigns the first priority to the first battery 102a, the second priority to the second battery 102b, the third priority to the third battery 102d, the fourth priority to the fourth battery 102d, and the fifth priority to the fifth battery 102e, and controls the charging of the five batteries 102a, 102b, 102c, 102d as per the assigned priorities.

In some embodiments, the controller 104 may determine that the batteries 102 connected to the charging station 100 are of different sizes. In such a case, the controller 104 may determine/calculate a charging time to full charge for each of the batteries 102. The controller 104 may determine the charging time for each of the batteries 102 based on the sizes of the batteries 102, current voltages of the batteries, etc. Upon determination of the charging time of each of the batteries 102, the controller 104 assigns priorities to the batteries 102 in the ascending order of the charging time with a battery having the lowest charging time being assigned the first priority (i.e., highest priority) and a battery having the highest charging time is assigned the lowest priority. After assigning the priority order of the batteries 102 connected to the charging station, the controller 104 controls the charging and charging current of each of the batteries 102 as discussed above to prevent the blowing of the fuse of the external power supply to which the charging station 100 is connected and receives electrical power.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A charging station for charging a plurality of batteries, the charging station comprising:
a plurality of charging terminals to facilitate the charging of the plurality of batteries; and
a controller arranged in communication with the plurality of charging terminals and configured to control the charging of the plurality of batteries in a first charging mode and a second charging mode, the controller is configured to
charge one of the plurality of batteries at a first charging current and in the first charging mode,
control the charging of one or more remaining batteries of the plurality of batteries to limit a total charging current of the charging station below a threshold value, wherein the one or more remaining batteries are charged at a second charging current and in the first charging mode, and
shift the charging of the one of the remaining batteries being charged at the second charging current from the second charging current to the first charging current in response to a completion of the charging of the one of the plurality of batteries being charged at the first charging current to a predetermined value,
wherein the first charging current is smaller of a first current value and a maximum permissible current of a battery determined to be charged at the first charging current.

2. The charging station of claim 1, wherein the second charging current is one of a second current value or a maximum permissible current of a battery determined to be charged at the second charging current.

3. The charging station of claim 2, wherein the controller
determines a remaining current value by subtracting a total of charging currents being provided to one or more batteries being charged from the threshold value, and
select the second current value as the second charging current when the remaining current value is less the maximum permissible current of the battery determined to be charged at the second charging current,
or
select the second charging current as the maximum permissibly current of the battery determined to be charged at the second charging current when the remaining current value is greater than or equal to the maximum permissible current of the battery determined to be charged at the second charging current.

4. The charging station of claim 1, wherein the controller is configured to charge one or more of the plurality of batteries having charge value greater than the predetermined value in the second charging mode.

5. The charging station of claim 1, wherein the controller is configured to
determine a priority order of charging of the plurality of batteries, and
control the charging of the plurality of batteries according to the priority order with a battery having a highest priority among the plurality of batteries being charged at the first charging current.

6. The charging station of claim 5, wherein the controller is configured to determine the priority order of charging of the plurality of batteries based on a voltage of each of the plurality of batteries when the plurality of batteries includes equal capacity.

7. The charging station of claim 6, wherein the controller is configured to assign a highest priority to a battery having a highest voltage among the plurality of batteries, and assign a lowest priority to a battery having a lowest voltage among the plurality of batteries.

8. The charging station of claim 5, wherein the controller is configured to determine the priority order of charging of the plurality of batteries based on a charging time of each of the plurality of batteries when the plurality of batteries includes different capacity.

9. The charging station of claim 8, wherein the controller is configured to assign a highest priority to a battery having a lowest charging time, and assign a lowest priority to a battery having a highest charging time.

10. The charging station of claim 1 further including a plurality of field effect transistors electrically coupled to the plurality of the charging terminals, wherein each of the plurality of field effect transistors controls a charging current being supplied to an associated charging terminal.

11. A charging station for charging a plurality of batteries, the charging station comprising:
a plurality of charging terminals to facilitate the charging of the plurality of batteries; and
a controller arranged in communication with the plurality of charging terminals and configured to control the charging of the plurality of batteries in a first charging mode and a second charging mode, the controller is configured to
determine a priority order of charging of the plurality of batteries,
control the charging of the plurality of batteries according to the priority order, wherein the controller is configured to
charge one of the plurality of batteries having a highest priority at a first charging current and in the first charging mode,
control the charging of one or more remaining batteries of the plurality of batteries to limit a total charging current of the charging station below a threshold value, wherein the one or more remaining batteries are charged at a second charging current and in the first charging mode, and
shift the charging of the one of the remaining batteries being charged at the second charging current from the second charging current to the first charging current in response to a completion of the charging of the one of plurality of batteries being charged at the first charging current to the predetermined value,
wherein the first charging current is smaller of a first current value and a maximum permissible current of a battery determined to be charged at the first charging current.

12. The charging station of claim 11, wherein the second charging current is one of a second current value or a maximum permissible current of a battery determined to be charged at the second charging current.

13. The charging station of claim 12, wherein the controller
determines a remaining current value by subtracting a total of charging currents being provided to one or more batteries being charged from the threshold value, and
select the second current value as the second charging current when the remaining current value is less the maximum permissible current of the battery determined to be charged at the second charging current,
or
select the second charging current as the maximum permissibly current of the battery determined to be charged at the second charging current when the remaining current value is greater than or equal to the maximum permissible current of the battery determined to be charged at the second charging current.

14. The charging station of claim 11, wherein the controller is configured to charge one or more of the plurality of batteries having a charge value greater than the predetermined value in the second charging mode to fully charge the one or more of the plurality of batteries.

15. The charging station of claim 11, wherein the controller is configured to determine the priority order of the plurality of batteries based on a voltage of each of the plurality of batteries when the plurality of batteries includes equal capacity.

16. The charging station of claim 15, wherein the controller is configured to assign a highest priority to a battery having a highest voltage, and assign a lowest priority to a battery having a lowest voltage.

17. The charging station of claim 11, wherein the controller is configured to the priority order of charging of the plurality of batteries based on a charging time of each of the plurality of batteries when the plurality of batteries includes different capacity.

18. The charging station of claim 17, wherein the controller is configured to assign a highest priority to a battery having a lowest charging time, and assign a lowest priority to a battery having a highest charging time.

19. A method for charging a plurality of batteries, the method comprising:
determining, by a controller, a priority order of the charging of the plurality of batteries connected to a plurality of charging terminals of a charging station,
controlling, by the controller, the charging of the plurality of the batteries according to the priority order,
charging, by the controller, a battery having a highest priority among the plurality of batteries at a first charging current and in a first charging mode,
controlling, by the controller, the charging of one or more remaining batteries of the plurality of batteries to limit a total charging current of the charging station below a threshold value, wherein the one or more remaining batteries are charged at a second charging current and in the first charging mode, and
shifting the charging of one of the one or more remaining batteries being charged at the second charging current from the second charging current to the first charging current in response to a completion of the charging of the battery being charged at the first charging current to the predetermined value,
wherein the first charging current is smaller of a first current value and a maximum permissible current of a battery determined to be charged at the first charging current.

20. The charging station of claim 19, wherein the controller is configured to determine the priority order of charging of the plurality of batteries based on
a voltage of each of the plurality of batteries when the plurality of batteries includes equal capacity, or
a charging time of each of the plurality of batteries when the plurality of batteries includes different capacity.
